(19) United States
(12) Patent Application Publication
(10) Pub. No.: US 2006/0185102 A1
(43) Pub. Date: Aug. 24, 2006

(54) Reactive dyestuff composition and their use

(75) Inventors: Bao-Kun Lai, Guanyin Township (TW); Te-Chin Sung, Guanyin Township (TW); Liang-Ming Lu, Guanyin Township (TW)

Correspondence Address: FISH & RICHARDSON PC, P.O. BOX 1022, MINNEAPOLIS, MN, 55440-1022, US

(73) Assignee: EVERLIGHT USA, INC.

(21) Appl. No.: 11/213,562

(22) Filed: Aug. 26, 2005

(30) Foreign Application Priority Data
Feb. 24, 2005 (CN) 2005100095888

(51) Int. Cl. C09B 62/20

(52) U.S. Cl. 8/549

(57) ABSTRACT

A dye composition, which comprising: (a) an azo dye of the formula (I) 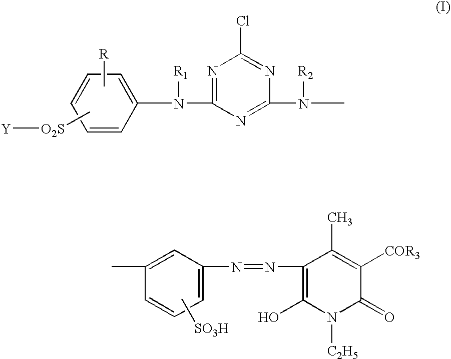
wherein R, R₁, R₂, R₃ and Y are defined the same as the specification; and (b) an azo dye of the formula (II) 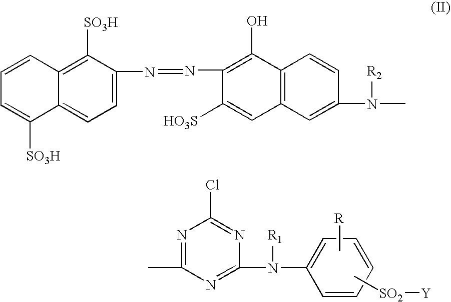
wherein R, R₁, R₂ and Y are defined the same as the specification. These kinds of dye composition with good stability and build-up. The dye composition are suitable for dyeing and printing of materials containing either cellulose fibers, such as cotton, viscose rayon, linen, and artificial linen, or synthetic polyamide, such as wool, silk, and nylon etc. Dyed materials with excellent properties can be obtained, showing especially outstanding performance in of wash-off, build-up, level-dyeing, wet fastness, ghosting fastness and light fastness.

### BACKGROUND OF THE INVENTION

1. Field of the Invention

The present invention relates to dye compositions and the use thereof, more particularly to yellow reactive dye compositions and the use of on dyes that are developed for particular textile finishes.

2. Description of Related Art

If the reactive dyestuffs are to be used for dyeing or printing cellulose fibers or cellulose containing fibers, high qualities are particularly needed in all aspects such as the properties of leveling, reproducibility, solubility, fastness and etc.

However the reactive dyestuffs available at present are short of a golden-yellow dye having ordinary build-up and ghosting fastness at the same time. These shortcomings exposed and can not be conquered while dyeing with pale shade and trichromatic combination.

With continuous attempts, the inventor of the present invention realized a golden-yellow dye characterized with fine ghosting fastness and build-up can be formed by mixing together yellow and orange dyes having good ghosting fastness. They are not only having superior characteristics of fastness properties, the dye compositions of the present invention are also capable of dyeing with a broad color gamut, and economic in achieving various fastness properties.

### SUMMARY OF THE INVENTION

The present invention provides a dye composition which has good ghosting fastness and build-up property. The dye compositions of the present invention are economic in dyeing pale shade and achieving various fastness properties as well. The dye compositions of the present invention can be mixed with conventional dyestuffs to overcome the drawbacks of build-up, phototropic property and the limited color gamut, thereby providing the market with a superb combination of ghosting fastness and build-up.

The dye compositions of the present invention comprising:

(a) an azo dye of the following formula (I) present in an amount ranging from 1% to 99% by weight relative to total weight of said composition, 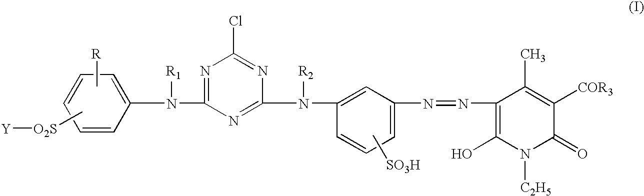
wherein
R is hydrogen, sulfo, C₁₋₄ alkyl or C₁₋₄ alkoxyl; R₁ and R₂ each independently is hydrogen or C₁₋₄ alkyl group unsubstituted or substituted by hydroxyl, sulfo, carboxyl or a cyano group; R₃ is amino or sulfo; Y is —CH═CH₂, —CH₂CH₂Cl or —CH₂CH₂OSO₃H; and

(b) an azo dye of the following formula (II) present in an amount ranging from 99% to 1% by weight relative to total weight of said composition, 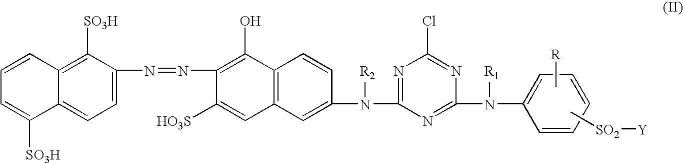
wherein R, R₁, R₂, and Y are defined the same as the above formula (I).

The dye composition of the present invention is preferably comprising the azo dye of the formula (I) in an amount ranging from 99% to 50% by weight relative to total weight of said composition, and the azo dye of the formula (II) in an amount ranging from 1% to 50% by weight relative to total weight of said composition. More preferably, the dye composition of the present invention is comprising the azo dye of the formula (I) in an amount ranging from 90% to 60% by weight relative to total weight of said composition, and the azo dye of the formula (II) present in an amount ranging from 10% to 40% by weight relative to total weight of said composition.

The formula (I) azo dye of the present invention is preferably the compound of the following formula (Ia): 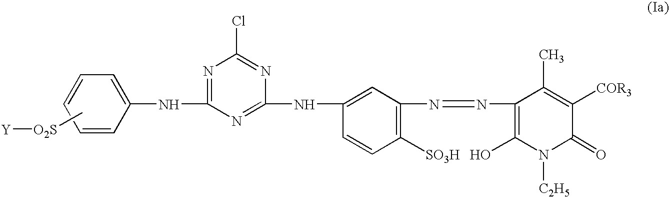
wherein R₃ is amino or sulfo; Y is —CH═CH₂, —CH₂CH₂Cl or —CH₂CH₂OSO₃H.

The formula (I) azo dye of the present invention is more preferably the compound of the following formula (Ib): 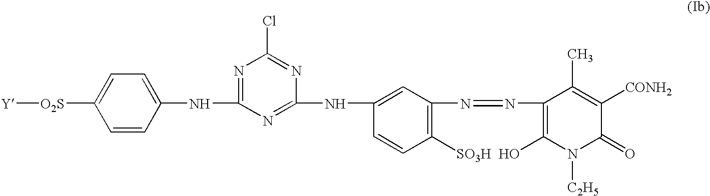
wherein Y′ is —CH═CH₂ or —CH₂CH₂OSO₃H. Most preferably, the formula (Ib) compound is the compound of the following formula (I-1):

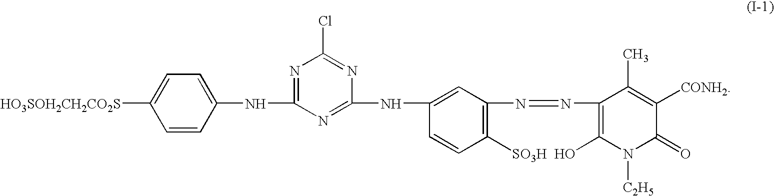

The formula (II) azo dye of the present invention is preferably the compound of the following formula (IIa): 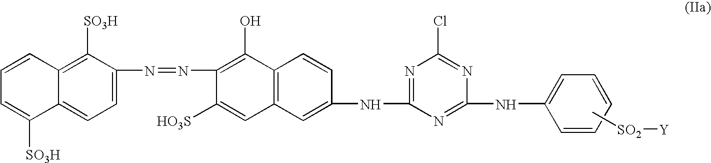
wherein Y is —CH═CH₂, —CH₂CH₂Cl or —CH₂CH₂OSO₃H.

The formula (II) azo dye of the present invention is more preferably the compound of the following formula (IIb): 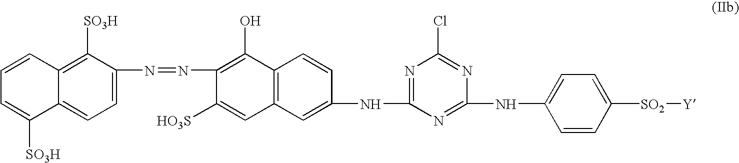
wherein Y′ is —CH═CH₂ or —CH₂CH₂OSO₃H. Most preferably, the formula (IIb) compound is the compound of the following formula (II-1):

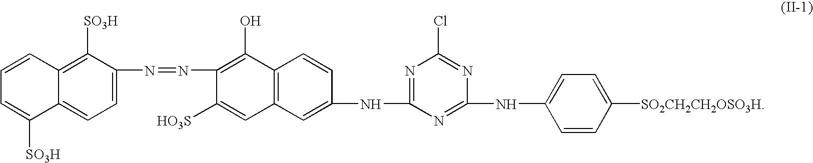

The dye composition of the present invention are suitable for dyeing materials that contain either cellulose fibers, such as cotton, artificial cotton, linen, and artificial linen, or synthetic polyamide, such as wool, silk, and nylon. Dyeing materials with dye composition above-mentioned will achieve excellent properties, especially in build-up and ghosting fastness.

The dye composition of the present invention can be mixed with conventional dyestuffs to overcome the drawbacks of discoloring, color distortion, and phototropic property, as well provide a superb ghosting fastness combination. Where in the pale shade aspect, after proceeded with the ghosting test, the practiced golden yellow components demonstrate red color distortion with insufficient blue components, as a result thereof, it is relatively obvious that the hues are induced with problems such as color distortion and discoloring. The dye composition of the present invention can effectively improve golden-yellow dyestuff ghosting fastness discoloration, particularly in dyeing extremely pale shade, where together with red and/or blue dyestuffs having good light fastness and ghosting fastness, after ghosting fastness testing only a remarkably small color distortion in hues with little extend of discoloring.

### DETAILED DESCRIPTION OF THE PREFERRED EMBODIEMENT

The synthesis of the compound of formula (I) of the present invention may refer to Poland Patent No. 162, 424.

The synthesis of compound of formula (II) of the present invention may refer to Japanese Patent No. 57,141,455.

The compositions of the present invention can be prepared in several ways. For example, the dye components can be prepared separately and then mixed together to make powder, granular and liquid forms, or a number of individual dyes may be mixed according to the dyeing recipes in a dye house. The dye mixtures of the present invention can be prepared, for example, by mixing the individual dyes. The mixing process is carried out, for example, in a suitable mill, such as a ball mill or a pin mill, or kneaders or mixers.

If necessary, the dye compositions of the present invention may be contained with inorganic salts (e.g. sodium sulfate or sodium chloride), dispersants (e.g. β-naphthalenesulfonic acid-formaldehyde condensation products, methylnaphthalenesulfonic acid-formaldehyde condensation products, acetylaminonaphthol based compounds, etc.), non-dusting agents (e.g. di-2-ethylhexyl terephthalate, etc.), pH buffer agents (e.g. sodium acetate, sodium phosphate, etc.), water softeners (e.g. polyphosphate, etc.), well-known dyeing assistants, and etc.

The form of the dye composition of the present invention is not critical. The dye composition can be powders, granules or liquids form.

For the convenience of description, the compounds are depicted as free acids in the specification. When the dyestuffs of the present invention are manufactured, purified or used, they exist in the form of water soluble salts, especially alkaline metallic salts, such as sodium salts, lithium salts, potassium salts or ammonium salts, and preferably sodium salts.

The dye compositions of the present invention can be used to dye a wide range of fiber materials, especially for cellulose fiber materials. These dye compositions can also be used to dye natural cellulose fibers and regenerated cellulose fibers, such as cotton, linen, jute, ramie, mucilage rayon, as well as cellulose based fibers.

The dyeing by using the dye compositions of the present invention can be any generally used process. Take exhaustion dyeing for example, it utilizes either inorganic neutral salts such as sodium sulfate anhydride and sodium chloride, or acid chelating agents such as sodium carbonate and sodium hydroxide, or both of them. The amount of inorganic neutral salts or base is not of concern, and can be added once or separately. In addition to that, it is optional to add traditionally used dyeing assistants, such as leveling agents and retarding agents. The temperature of dyeing ranges from 40° C. to 90° C., and preferably 50° C. to 70° C.

A cold batch-up dyeing method firstly carried out pad-dyeing by using inorganic neutral salts such as sodium sulfate anhydride and sodium chloride, and acid chelating agents such as sodium silicate and sodium hydroxide, and then the materials were rolled up to start dyeing.

Continuous dyeing is single batch-up dyeing, which mixes a well-known acid chelating agent such as sodium carbonate or sodium bicarbonate with a pad-dyeing liquor, and pad-dyeing is carried out. After that, the dyed materials are dried or evaporated to fix the color, and then the dyed materials are treated with well-known inorganic neutral salts such as sodium sulfate anhydride and sodium chloride, and acid chelating agents such as sodium hydroxide or sodium silicate. Preferably, the treated materials are dried or evaporated again by common methods to is finally fix the color.

Among textile printing methods, a one-way printing method utilizes a printing paste containing an acid chelating agent such as sodium bicarbonate to print the materials, thereafter the printed materials are dried or evaporated to fix the color. However, a two-phase printing method includes printing by printing paste and fixing color by soaking the printed materials in high temperature (90° C. or above) solution containing inorganic neutral salts (like sodium chloride) and acid chelating agents (like sodium hydroxide or sodium silicate). The dyeing methods of the present invention are not restricted to the aforementioned methods.

The dye compositions of the present invention not only have excellent fixative ability and build up, but are also provided with good properties in darkness of colors, levelness, cleaning, solubility, and exhausting and fixative extent. Therefore, exhaustion dyeing at a low temperature and pad dyeing can be carried out in a short period of time. The dyed products are highly fixative and minimally damaged after soap cleaning.

The dye composition of the present invention exhibits superior hue and excellent cellulose-dyestuff combination stability in dyeing cellulose fiber materials, no matter the dyeing environment is acid or base. Besides, the dyed cellulose fiber materials have good properties of light fastness, wet-light fastness, ghosting fastness, and wet fastness, e.g. clean fastness, water fastness, sea water fastness, cross-dyeing fastness, and perspiration fastness, as well as fastness of wrinkling, ironing, and friction. Therefore, it is a valuable reactive yellow dye for cellulose fibers in the dyeing industry. The dye compositions have the materials dyed with excellent properties and resulted in outstanding build-up, ghosting fastness and light fastness. Owing to the change of the demand of the market, the general reactive dyestuff will not meet the requirements of the extremely light color and melange market any more. The dye compositions of the present invention exhibit better perspiration-light fastness in light color, and particularly in melange of extremely light color, which leads to fit in with the requirements and expectations of market.

Many examples have been used to illustrate the present invention. The examples sited below should not be taken as a limit to the scope of the invention. In these examples, the compounds are represented in the form of dissolved acid. However, in practice, they will exist as alkali salts for mixing and salts for dyeing.

In the following examples, quantities are given as parts by weight (%) if there is no indication. The relationship between weight parts and volume parts are the same as that between kilogram and liter.

### EXAMPLE 1

Take 90 weight parts of the formula (I-1) compound and 10 weight parts of the formula (II-1) compound and mixed completely to form a dye composition.

### EXAMPLE 2

Take 75 weight parts of the formula (I-1) compound and 25 weight parts of the formula (II-1) compound and mixed completely to form a dye composition.

### EXAMPLE 3

Take 60 weight parts of the formula (I-1) compound and 40 weight parts of the formula (II-1) compound and mixed completely to form a dye composition.

### COMPARATIVE EXAMPLES

Selecting the high sale volume and widely used golden-yellow dye product, such dyes can be selected from the Color Index, for example: C.I. Reactive Yellow 176, C.I. Reactive Orange 107, C.I. Reactive Yellow 84 or the mixture of as the reference to compare with for the dye property testing of the present invention.

The dye composition ratios of comparative examples 1-3 are shown in table 1 below:

TABLE 1

| Comparative | C.I. Reactive | C.I. Reactive | C.I. Reactive |
|---|---|---|---|
| Examples | Yellow 176 | Orange 107 | Yellow 84 |
| Comparative | 100 parts | — | — |
| Comparative | 20 parts | 80 parts | — |
| Comparative | — | — | 100 parts |

### TEST EXAMPLE 1

Ghosting-Shade Change Testing by Exhaustion Dyeing

Each dye composition of comparative examples 1-3 and examples 1-3 of the present invention are tested with single color and trichromatic combination of yellow, red and blue for Ghosting-Shade Change, and the following are the testing procedures and results.

Testing procedures: First of all, 80 ml dye liquors are prepared, wherein each respectively has a concentration of 0.1% on the weight of the fabric (o.w.f). After, inorganic neutral salts are added, and then dyeing of un-mercerized cloth of pure cotton is started. The un-mercerized cotton cloths are soaked in the dye liquors. At the same time, dyeing of the dyestuffs is proceeded under 60° C. where then the dyestuffs start diffusing to adhere the cloths with the aid of a horizontal shaker, which is followed by adding an alkali agent that allows the dyestuffs to react with fiber completely to achieve firm adherence. The resulting dyed cloths are water cleaned, soaped off, and tumble-dried to from finished products.

Follow up a mesh printing screen of an area of 2″×4″ is placed over the aforementioned finished dye cloth samples, then Solar White Plastisol S9027LB (manufactured by PolyOne Corp.) printing paste is applied on top and evenly printed with a stainless steel rod for a total of two runs (back and forth). The printing paste on top of the testing samples are bake dried under 110° C. x60 seconds, and further heated to shape under elevated temperature of 163° C. (325° F.) for 60 seconds, and allow the printing paste to fully react with the testing samples, then taken out to rewetting for two hours. After the samples are soaked in water, and the excess amount of water are removed to maintain a humidity of 100%, then both the printed and unprinted samples are folded and placed in a sublimation fastness device under 120° C.×30 min. The processed samples are then proceeded with AATCC EP 1 color distortion comparison.

Testing result: the results of Ghosting-Shade Change testing by exhaustion dyeing are shown in the following table 2 and table 3 below.

TABLE 2

| | 0.1% dye concentration (o.w.f) |
|---|---|
| Example 1 | 5 |
| Example 2 | 5 |
| Example 3 | 5 |
| Comparative Example 1 | 1 |
| Comparative Example 2 | 1 |
| Comparative Example 3 | 1 |

TABLE 3

| Trichromatic combination of yellow, | |
|---|---|
| red and blue | 0.1% dye concentration (o.w.f) |
| Example 1 | 5 |
| Everzol Red 3BS | |
| Everzol Blue BRF | |
| Example 2 | 5 |
| Everzol Red 3BS | |
| Everzol Blue BRF | |
| Example 3 | 5 |
| Everzol Red 3BS | |
| Everzol Blue BRF | |
| C.I. Reactive Yellow 176 | 1 |
| Everzol Red 3BS | (tends to red, and blue) |
| Everzol Blue BRF | |

In the result of single color, the composition of examples 1-3 of the present invention confirms the superiority over comparative examples 1-3.

The dyeing strength and the discoloring condition of the dyed and Ghosting-Shade Change tested compositions of the afore examples 1-3, comparative examples 1-3, and the trichromatic combination of yellow, red and blue are compare with the condition prior to test with a DATA MATCH computer metering system, where the higher degree of dyeing and the lesser extend of discoloring are preferred. The dye compositions of the examples 1-3 of the present invention having high level of hue intensity with little changes showing good ghosting fastness and are of level 5. Similarly, the trichromatic combination of yellow, red and blue comprising of the components of the dye compositions of example 1 of the present invention having high level of hue intensity with little changes showing good ghosting fastness and are of level 5. This demonstrates the dye compositions of examples 1-3 of the present invention is superior with respect to other golden-yellow dyestuffs.

The dye compositions of the present invention are suitable for common use and have excellent properties. They can be used to dye cellulose fibers with various dyeing methods, such as exhaustion dyeing, printed-dyeing, or continuous dyeing that are commonly used in the dyeing of reactive dyestuffs.

The dye compositions of the present invention are water-soluble dyestuffs having high commercial value. The dye compositions of the present invention can obtain dyeing results with excellent properties in all aspects, especially in washing off, build-up, levelness, ghosting fastness, light fastness and wet-light fastness.

From the foregoing description, regardless of the objects, the techniques, the effects or the skill aspects and developments, the present invention is distinctive with respect to known skills. Although the present invention has been explained in relation to its preferred embodiment, it is to be understood that many other possible modifications are variations can be made without departing from the scope of the invention as hereinafter claimed.

1. A golden-yellow dye composition comprising
(a) an azo dye of the following formula (I) present in an amount ranging from 1% to 99% by weight relative to total weight of said composition, 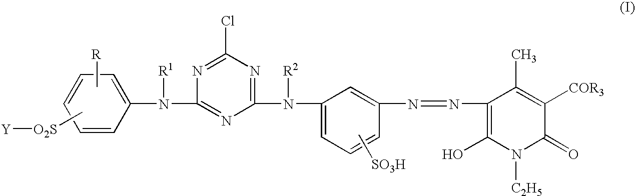
wherein
R is hydrogen, sulfo, C₁₋₄ alkyl or C₁₋₄ alkoxyl; R₁ and R₂ each independently is hydrogen or C₁₋₄ alkyl group unsubstituted or substituted by hydroxyl, sulfo, carboxyl or cyano group; R₃ is amino or sulfo; Y is —CH═CH₂, —CH₂CH₂C1 or —CH₂CH₂OSO₃H; and
(b) an axo dye of the following formula (II) present in an amount ranging from 99% to 1% by weight relative to total weight of said composition, 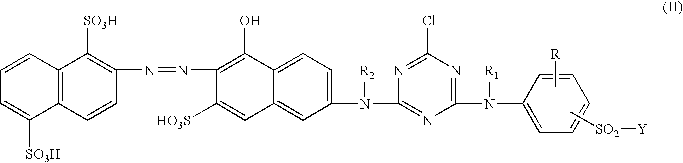
wherein
R is hydrogen, sulfo, C₁₋₄ alkyl or C₁₋₄ alkoxyl; R₁ and R₂ each independently is hydrogen or C₁₋₄ alkyl group unsubstituted or substituted by hydroxyl, sulfo, carboxyl or a cyano group; Y is —CH═CH₂, —CH₂CH₂Cl or —CH₂CH₂OSO₃H.

2. The dye composition of claim 1, wherein said azo dye of the formula (I) is present in an amount ranging from 99% to 50% by weight relative to total weight of said composition, and said azo dye of the formula (II) is present in an amount ranging from 1% to 50% by weight relative to total weight of said composition.

3. The dye composition of claim 1, where in said azo dye of the formula (I) is present in an amount ranging from 90% to 60% by weight relative to total weight of said composition, and said azo dye of the formula (II) is present in an amount ranging from 10% to 40% by weight relative to total weight of said composition.

4. The dye composition of claim 1, wherein the formula (I) is the compound of the following formula (Ia): 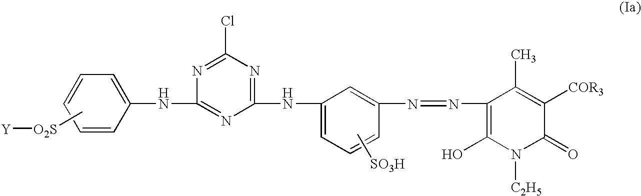
wherein
R₃ is amino or sulfo; and Y is —H═CH₂, —CH₂CH₂Cl or —CH₂CH₂OSO₃H.

5. The dye composition of claim 1, wherein the formula (II) is the compound of the following formula (IIa): 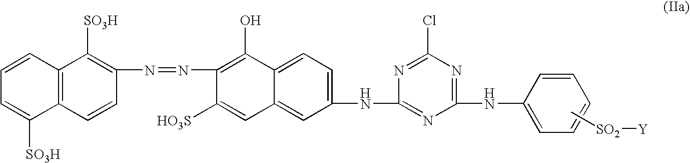
wherein
Y is —CH═CH₂, —CH₂CH₂Cl or —CH₂CH₂OSO₃H.

6. The dye composition of claim 1, wherein the formula (I) is the compound of the following formula (Ib): 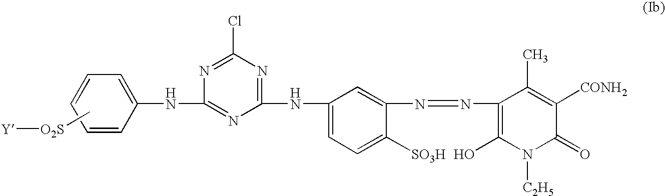
wherein
Y′ is —CH═CH₂ or —CH₂CH₂OSO₃H.

7. The dye composition of claim 1 wherein formula (II) is the compound of the following formula (IIb): 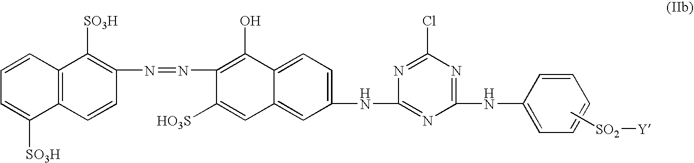
wherein
Y′ is —CH═CH2 or —CH₂CH₂OSO₃H.

8. The dye composition of claim 6, wherein the formula (Ib) is the compound of the following formula (I-1):

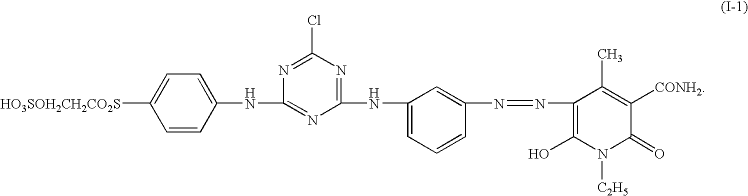

9. The dye composition of claim 7, wherein the formula (IIb) is the compound of the following formula (II-1): [chemical structure]
